(19) United States
(12) Patent Application Publication
(10) Pub. No.: US 2012/0152024 A1
(43) Pub. Date: Jun. 21, 2012

(54) DISTRIBUTED ACOUSTIC SENSING (DAS)-BASED FLOWMETER

(76) Inventor: ESPEN S. JOHANSEN, The Palh (AE)

(21) Appl. No.: 12/972,235

(22) Filed: Dec. 17, 2010

(51) Int. Cl. G01F 1/66; G01H 9/00

(52) U.S. Cl. 73/655; 73/861.25

(57) ABSTRACT

Methods and apparatus for sensing fluid flow within a conduit using a Distributed Acoustic Sensing (DAS) system. The DAS system may lower production costs and may offer some technical advantages over fiber Bragg grating (FBG)-based flowmeters such as auxiliary measurement of strain from the wellhead down to the flowmeter. The DAS system may also simplify multiplexing multiple flowmeters on a single fiber.

### BACKGROUND OF THE INVENTION

1. Field of the Invention

Embodiments of the invention generally relate to fluid flow sensing devices that use fiber optics and, more particularly, to those devices that are interrogated using a Distributed Acoustic Sensing (DAS) system.

2. Description of the Related Art

The world's reservoirs are aging. This translates to increased water production and gas coning, increased lifting costs, expensive treatment of produced water, and high cost of deferred or lost hydrocarbon production. Hence, it is getting increasingly important to limit the drawdown from reservoirs and monitor the water production and gas coning. Downhole flowmeters can measure the water production from multiple zones or laterals in real time and, if combined with downhole flow control, can be used to take immediate remedial action when water onset is detected.

In the hydrocarbon industry, there is considerable value associated with the ability to monitor the flow of hydrocarbon products in the production pipe of a well in real time. Historically, flow parameters such as the bulk velocity of a fluid have been sensed with Venturi type devices directly disposed within the fluid flow. These devices have several drawbacks, including that they provide an undesirable flow impediment, are subject to the hostile environment within the pipe, and typically provide undesirable potential leak paths into or out of the pipe. In addition, these devices are only able to provide information relating to bulk fluid flow and are unable to provide information specific to constituents within a multiphase flow.

Some techniques utilize the speed of sound to determine various parameters of the fluid flow within a pipe. One technique measures the amount of time it takes for sound signals to travel back and forth between ultrasonic acoustic transmitters/receivers (transceivers). This is sometimes referred to as a “Doppler” or “transit time” method. U.S. Pat. Nos. 4,080,837, 4,114,439, and 5,115,670 disclose variations of this method. A disadvantage of this type of technique is that gas bubbles and/or particulates in the fluid flow can scatter and attenuate the signals traveling between the transceivers. Another disadvantage of this type of technique is that it considers only the fluid disposed between transceivers during the signal transit time. Fluid flow within a well is often non-homogeneous. For example, the fluid flow may contain localized concentration variations (“slugs”) of water or oil. The localized concentration variations may affect the accuracy of the data collected.

One prior art technique of sensing a parameter within a body is disclosed in U.S. Pat. No. 4,950,883 to Glenn, wherein a broadband source is used in cooperation with a Fabry-Perot resonator sensor. The high reflectivity gratings establish a resonant signal, the wavelength of which is indicative of the parameter of interest of a fluid within the body. Among other shortcomings, this prior art method has limited usefulness in a downhole environment for several reasons, such as limited resolution.

Multiphase flowmeters can be used to measure the flow rates of individual constituents within a fluid flow (e.g., a mixture of oil, gas, and water) without requiring separation of the constituents. Most of the multiphase flowmeters that are currently available, however, are designed for use topside at the wellhead or platform. A problem with utilizing a flowmeter at the wellhead of a multi-zone or multi-lateral well is that the flow contribution from each of the zones or laterals cannot be directly determined.

Downhole flowmeters have been based on an array of spatially distributed strain sensors. Each individual sensor consists of a coil of fiber and two fiber Bragg gratings (FBGs) and is interrogated using a sophisticated surface-based optical-electronic instrument. The interrogation is based on measurement of interference of two optical pulses at least partially reflected from the FBGs.

### SUMMARY OF THE INVENTION

One embodiment of the present invention provides a method. The method generally includes introducing light in an optical waveguide wrapped along a length of a conduit; measuring a time difference between disturbances in the light propagating along the optical waveguide by measuring reflections that are backscattered along the optical waveguide, wherein the disturbances are caused by vortical or acoustic signals traveling along the length of the conduit and wherein the time difference is measured between at least two sections of the optical waveguide; and determining at least one of a speed of sound or a flow velocity of a fluid associated with the vortical or the acoustic signals, based on the time difference.

Another embodiment of the present invention provides an apparatus. The apparatus generally includes a conduit; an optical waveguide wrapped along a length of the conduit; means for introducing light in the optical waveguide; means for measuring a time difference between disturbances in the light propagating along the optical waveguide by measuring reflections that are backscattered along the optical waveguide, wherein the disturbances are caused by vortical or acoustic signals traveling along the length of the conduit and wherein the time difference is measured between at least two sections of the optical waveguide; and means for determining at least one of a speed of sound or a flow velocity of a fluid associated with the vortical or the acoustic signals, based on the time difference.

Yet another embodiment of the present invention provides a Distributed Acoustic Sensing (DAS) system. The DAS system generally includes a conduit, an optical waveguide wrapped along a length of the conduit, an optical source for introducing light in the optical waveguide, and instrumentation. The instrumentation is typically configured to measure a time difference between disturbances in the light propagating along the optical waveguide by measuring reflections that are backscattered along the optical waveguide, wherein the disturbances are caused by vortical or acoustic signals traveling along the length of the conduit and wherein the time difference is measured between at least two sections of the optical waveguide; and to determine at least one of a speed of sound or a flow velocity of a fluid associated with the vortical or the acoustic signals, based on the time difference.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a diagrammatic view of a well having a pipe inside a casing and flowmeters positioned at various locations along the pipe, according to an embodiment of the present invention.

FIG. 2 illustrates a prior art flowmeter comprising a series of fiber coils separated by fiber Bragg gratings (FBGs).

FIG. 3 illustrates a flowmeter comprising a series of fiber coils separated by strain-isolated fiber, according to an embodiment of the present invention.

FIG. 4 illustrates a flowmeter comprising a coil of fiber spanning the length of the flowmeter, according to an embodiment of the present invention.

FIG. 5 is a flow diagram of exemplary operations for sensing fluid flow and/or a speed of sound within a conduit using a DAS system, according to an embodiment of the present invention.

### DETAILED DESCRIPTION

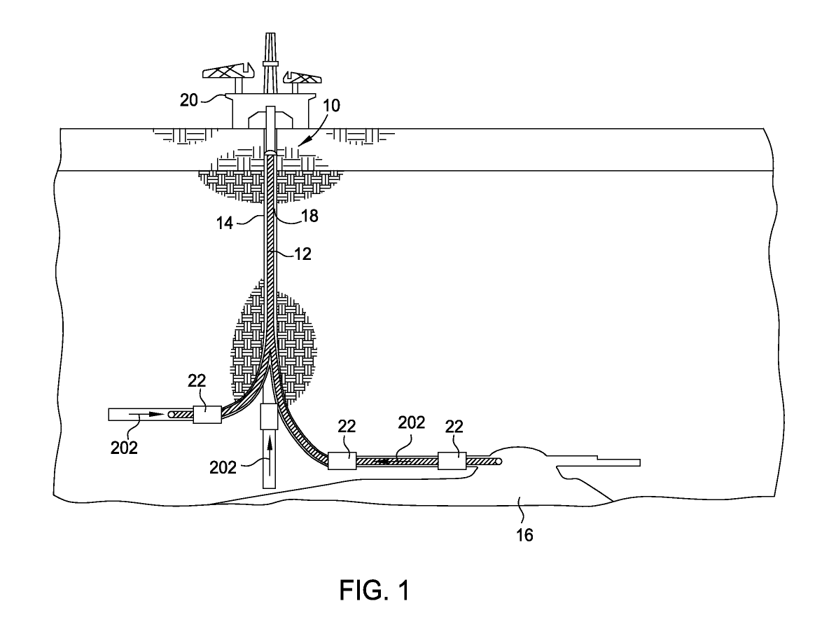

Referring to FIG. 1, there is shown an intelligent oil well system 10 containing one or more production pipes 12 (also known as production tubing) that may extend downward through a casing 14 to one or more hydrocarbon sources 16. An annulus 18 may exist between the pipe 12 and the casing 14. Each production pipe 12 may include one or more lateral sections that branch off to access different hydrocarbon sources 16 or different areas of the same hydrocarbon source 16. The fluid mixture may flow from sources 16 to the platform 20 through the production pipes 12, as indicated by fluid flow 202. The fluid mixtures may comprise hydrocarbon products and water. The production pipe 12 may comprise one or more flowmeters 22 for non-intrusively sensing fluid flow within a pipe or other conduit as the fluid mixtures flow through the production pipes 12.

Each flowmeter 22 may be incorporated into an existing section of production pipe 12 or may be incorporated into a specific pipe section that is inserted in line with the production pipe 12. The distributed scheme of flowmeters 22 shown in FIG. 1 may permit an operator of an intelligent well system 10 to determine the extent and location of breakthrough of water into the hydrocarbon reservoir. This information may permit the operator to monitor and intelligently control production of the hydrocarbon reservoir.

The flowmeters 22 may receive optical power and transmit optical signals via fiber optic cables that extend between the flowmeters 22 and instrumentation residing on the platform 20 or at a remote location in communication with the platform 20. The optical signals transmitted by the flowmeters 22 may provide information relating to the fluid flow characteristics within the pipe 12 (e.g., local flow disturbances, acoustic wave propagation within the flow, flow pressure magnitude and changes, etc.). Interpretation of the optical signals, which may be performed using methods well known in the art, may enable the determination of the speed of sound (SOS) of the fluid mixture and the velocity of the fluid flow within the pipe 12. Once the SOS, the flow velocity, the pressure, and the temperature of the mixture are known, other desirable data, such as the phase fraction of the constituents within the mixture, may be determined. The optical signals from the flowmeters 22 may also be interpreted using the methods disclosed in the following U.S. patents, but are not limited to being used therewith: U.S. Pat. No. 6,435,030 to Gysling et al.; U.S. Pat. No. 6,463,813 to Gysling; U.S. Pat. No. 6,354,147 to Gysling et al.; and U.S. Pat. No. 6,450,037 to McGuinn, all of which are hereby incorporated by reference.

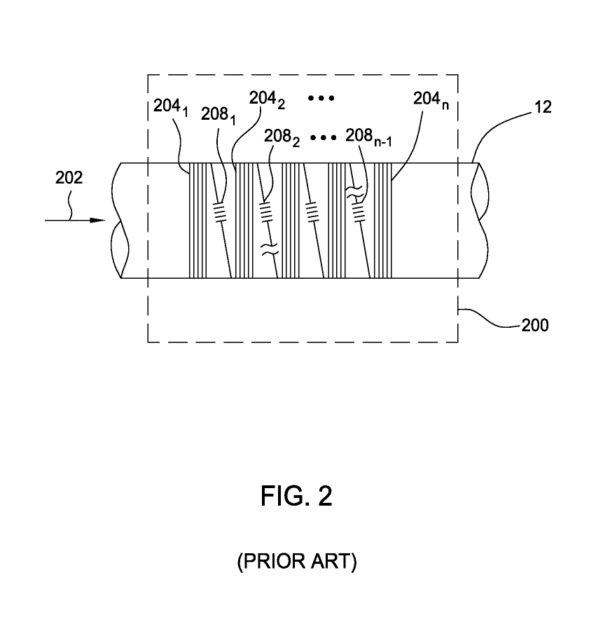

One prior art technique for sensing fluid flow within a pipe is disclosed in U.S. Pat. No. 6,785,004 to Kersey et al. and a corresponding flowmeter 200 is illustrated in FIG. 2. The flowmeter 200 may replace flowmeter 22 in FIG. 1. As illustrated in FIG. 2, a flowmeter 200 is based on an array of spatially distributed strain sensors. Each individual sensor consists of a coil of fiber (204₁-204ₙ) and two fiber Bragg gratings (FBGs) (208₁-208ₙ₋₁) that separate the coils of fiber (204₁-204ₙ). The sensors are interrogated using a surface-based optical-electronic instrument. The method is based on measurement of interference of two optical pulses. However, multiplexing flowmeters (comprising multiple, discrete sensors) may be complex, and manufacturing costs may be high. Accordingly, what is needed are techniques and apparatus for lowering production costs and simplifying the multiplexing of flowmeters.

For some embodiments of the present invention, the sensor configuration illustrated in FIG. 2 may be replaced by a series of fiber coils separated by strain-isolated fiber, wherein FBGs may not be required. The strain-isolated fiber may function as markers separating the sensors. These sensors may be interrogated using a Distributed Acoustic Sensing (DAS) unit, as will be described further herein.

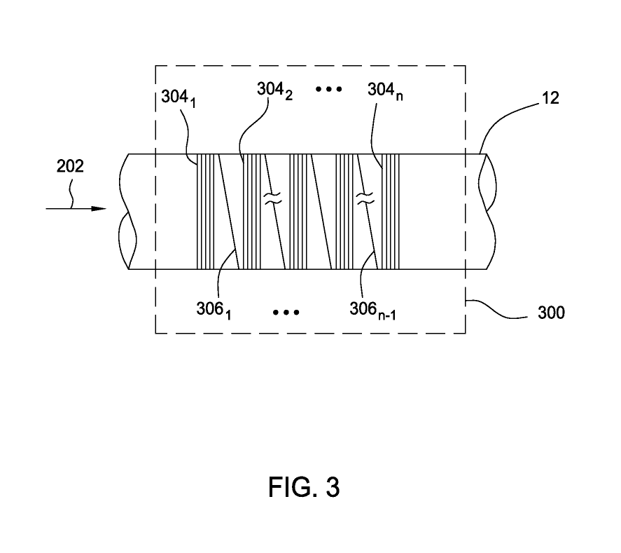

FIG. 3 illustrates an embodiment of a flowmeter 300 comprising a series of fiber coils (304₁-304ₙ) separated by strain-isolated fiber (306₁-306ₙ₋₁) that may be interrogated using a DAS unit, in accordance with certain aspects of the present invention. The flowmeter 300 may replace flowmeter 22 in FIG. 1. The fiber coils 304 may comprise a single layer of optical fiber turns or multiple layers of optical fiber turns, depending on the application. The fiber coils 304 may be attached to the production pipe 12 or other conduit by any of various suitable attachment mechanisms, including, but not limited to, adhesive, glue, epoxy, or tape. For some embodiments, the series of fiber coils (304₁-304ₙ) may be separated by non-strain-isolated fiber (e.g., attached to the production pipes 12). The DAS unit, which may comprise instrumentation residing on the platform 20 or at a remote location in communication with the platform 20, may introduce an optical pulse, using a pulsed laser, for example, into the flowmeter 300. As illustrated in FIG. 1, the well system 10 may comprise multiple flowmeters, wherein the multiple flowmeters may be multiplexed on a single fiber.

The DAS unit may also sense disturbances in the light propagating through the flowmeter 300. For some embodiments, the disturbances in the light may be due to acoustic signals that may be generated passively, such as sounds produced from a valve or a turbulent flow within the production pipes 12. For other embodiments, the disturbances in the light may be due to acoustic signals that may be generated by an acoustic energy source, wherein the acoustic energy source produces acoustic stimulation along a length of the production pipes 12. For other embodiments, the disturbances in the light may be due to vortical signals as the fluid flows within the production pipes. Vortically moving fluid moves around in a circle or in a helix or tends to spin around some axis. Although the vortically moving fluid also produces acoustic signals that travel at the speed of sound, the vortical signals travel at the fluid velocity. The acoustic or the vortical signals may change the index of refraction of the coils (304₁-304ₙ) in the flowmeter 300 or mechanically deform the coils (304₁-304ₙ) such that the Rayleigh scattered signal changes. The DAS unit may send an optical signal into the flowmeter 300 and may look at the naturally occurring reflections that are scattered back all along the optical fiber of flowmeter 300 (i.e., Rayleigh backscatter).

By analyzing the disturbances in the light due to the acoustic (or the vortical) signals, the DAS unit may be able to measure the effect of the acoustic (or the vortical) signals on the optical signal at all points along the flowmeter 300, limited only by spatial resolution. Moreover, as the acoustic (or the vortical) signal travels along the production pipe 12, the DAS unit may determine a flow velocity of a fluid associated with the acoustic (or the vortical) signal by measuring a time difference between the disturbances in the light caused by the acoustic (or the vortical) signal traveling between at least two sections along a flowmeter 300.

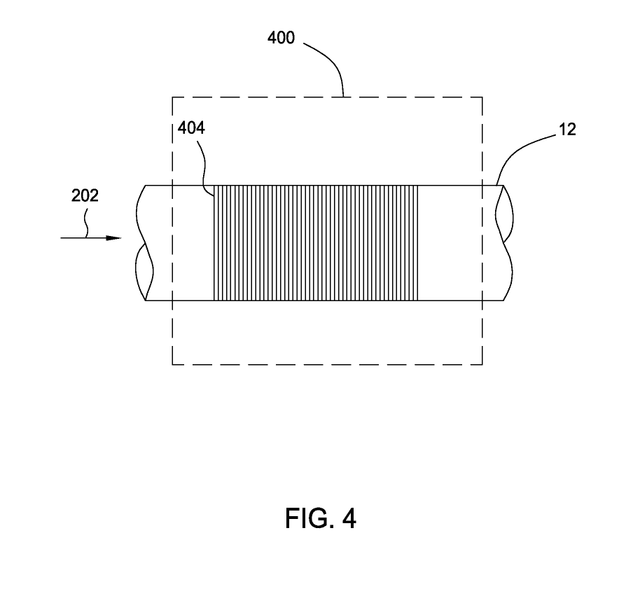

FIG. 4 illustrates another embodiment of a flowmeter 400, in accordance with certain aspects of the present invention. The flowmeter 400 may replace flowmeter 22 in FIG. 1. Rather than having coils of fiber separated by strain-isolated fiber as illustrated in FIG. 3, flowmeter 400 may comprise a coil of fiber 404 spanning the length of the flowmeter 400 (i.e., a continuous sensor). A DAS system may be capable of producing the functional equivalent of tens, hundreds, or even thousands of acoustic sensors along the coil of fiber 404. In other words, DAS technology may allow continuous sensing along a length of a conduit rather than requiring multiple, discrete sensors.

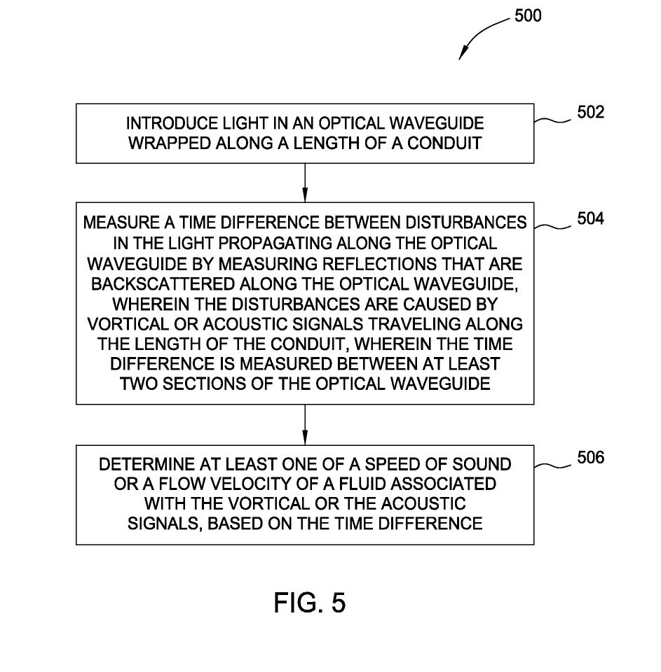

FIG. 5 illustrates operations 500 for sensing fluid flow and/or a speed of sound within a conduit using a DAS system, according to certain embodiments of the present invention. The operations 500 may begin, at 502, by a DAS unit introducing light (e.g., an optical signal) in an optical waveguide wrapped along a length of a conduit. For example, the DAS unit may introduce an optical pulse (using a pulsed laser or other suitable optical source) into one or more flowmeters 300, 400 located along a production pipe 12.

At 504, the DAS unit may measure a time difference between disturbances in the light propagating along the optical waveguide by measuring reflections that are backscattered along the optical waveguide, wherein the disturbances are caused by vortical or acoustic signals traveling along the length of the conduit and wherein the time difference is measured between at least two sections of the optical waveguide. For some embodiments, the time difference may be measured between two different coils 304. For other embodiments, the time difference may be measured between two different sections of a coil 404 spanning a length of a flowmeter. The DAS unit may measure the time difference by measuring a time between similar changes occurring in the backscattered reflections from the at least two sections of the optical waveguide.

At 506, the DAS unit may determine at least one of a speed of sound or a flow velocity of a fluid creating or otherwise associated with the vortical or the acoustic signals, based on the time difference. For some embodiments, the flow velocity may be output to a display, a printer, or any suitable output device.

A DAS system, as described herein, may lower production costs and may offer technical advantages over the FBG-based flowmeter, such as auxiliary measurement of strain from the wellhead down to the flowmeter. The DAS system may also simplify multiplexing multiple flowmeters on a single fiber without the complexity of wavelength division multiplexing (WDM), for example.

While the foregoing is directed to embodiments of the present invention, other and further embodiments of the invention may be devised without departing from the basic scope thereof, and the scope thereof is determined by the claims that follow.

What is claimed is:

1. A method, comprising:
introducing light in an optical waveguide wrapped along a length of a conduit;
measuring a time difference of disturbances in the light propagating along the optical waveguide by measuring reflections that are backscattered along the optical waveguide, wherein the disturbances are caused by vortical or acoustic signals traveling along the length of the conduit and wherein the time difference is measured between at least two sections of the optical waveguide; and
determining at least one of a speed of sound or a flow velocity of a fluid associated with the vortical or the acoustic signals, based on the time difference.

2. The method of claim 1, wherein introducing the light comprises introducing an optical pulse using a pulsed laser.

3. The method of claim 1, wherein the vortical or the acoustic signals change an index of refraction of the optical waveguide.

4. The method of claim 1, wherein the vortical or the acoustic signals mechanically deform the optical waveguide such that a Rayleigh scattered signal changes.

5. The method of claim 1, wherein measuring the time difference comprises measuring a time between similar changes occurring in the backscattered reflections from the at least two sections of the optical waveguide.

6. The method of claim 1, wherein the optical waveguide wrapped along the length of the conduit comprises a series of fiber coils, each pair of coils separated by a length of optical fiber.

7. The method of claim 6, wherein the length of optical fiber is strain isolated.

8. An apparatus, comprising:
a conduit;
an optical waveguide wrapped along a length of the conduit;
means for introducing light in the optical waveguide;
means for measuring a time difference of disturbances in the light propagating along the optical waveguide by measuring reflections that are backscattered along the optical waveguide, wherein the disturbances are caused by vortical or acoustic signals traveling along the length of the conduit and wherein the time difference is measured between at least two sections of the optical waveguide; and
means for determining at least one of a speed of sound or a flow velocity of a fluid associated with the vortical or the acoustic signals, based on the time difference.

9. The apparatus of claim 8, wherein the means for introducing the light comprises a pulsed laser for introducing an optical pulse.

10. The apparatus of claim 8, wherein the vortical or the acoustic signals change an index of refraction of the optical waveguide.

11. The apparatus of claim 8, wherein the vortical or the acoustic signals mechanically deform the optical waveguide such that a Rayleigh scattered signal changes.

12. The apparatus of claim 8, wherein the means for measuring the time difference comprises means for measuring a time between similar changes occurring in the backscattered reflections from the at least two sections of the optical waveguide.

13. The apparatus of claim 8, wherein the optical waveguide wrapped along the length of the conduit comprises a series of fiber coils, each pair of coils separated by a length of optical fiber.

14. A Distributed Acoustic Sensing (DAS) system, comprising:
a conduit;
an optical waveguide wrapped along a length of the conduit;
an optical source for introducing light in the optical waveguide; and
instrumentation configured to:
measure a time difference of disturbances in the light propagating along the optical waveguide by measuring reflections that are backscattered along the optical waveguide, wherein the disturbances are caused by vortical or acoustic signals traveling along the length of the conduit and wherein the time difference is measured between at least two sections of the optical waveguide; and
determine at least one of a speed of sound or a flow velocity of a fluid associated with the vortical or the acoustic signals, based on the time difference.

15. The system of claim 14, wherein the optical source comprises a pulsed laser and the light comprises an optical pulse produced by the pulsed laser.

16. The system of claim 14, wherein the vortical or the acoustic signals change an index of refraction of the optical waveguide.

17. The system of claim 14, wherein the vortical or the acoustic signals mechanically deform the optical waveguide such that a Rayleigh scattered signal changes.

18. The system of claim 14, wherein the instrumentation is configured to measure the time difference by measuring the time between similar changes occurring in the backscattered reflections from the at least two sections of the optical waveguide.

19. The system of claim 14, wherein the optical waveguide wrapped along the length of the conduit comprises a series of fiber coils, each pair of coils separated by a length of optical fiber.

20. The system of claim 14, wherein the conduit comprises production pipe.
